(19) United States
(12) Patent Application Publication
(10) Pub. No.: US 2024/0234869 A1
(43) Pub. Date: Jul. 11, 2024

(54) MANIFOLD ASSEMBLY FOR BATTERY PACK

(71) Applicant: Ford Global Technologies, LLC, Dearborn, MI (US)

(72) Inventors: Liam E. West, Ferndale, MI (US); Nathan Lee, Novi, MI (US); Wen Dai, Northville, MI (US)

(21) Appl. No.: 18/095,708

(22) Filed: Jan. 11, 2023

(51) Int. Cl. H01M 10/6568; H01M 10/6556; H01M 50/209

(52) U.S. Cl. CPC H01M 10/6568; H01M 10/6556; H01M 50/209

(57) ABSTRACT

This disclosure relates generally to battery packs for electrified vehicles, and in particular relates to a manifold assembly for a battery pack. In some aspects, the techniques described herein relate to a battery pack, including: a battery array including a plurality of battery cells; a thermal exchange plate, wherein the thermal exchange plate includes a channel configured to communicate fluid from a first side of the thermal exchange plate to a second side of the thermal exchange plate; and a manifold assembly including a cap connected to the first side of the thermal exchange plate, wherein the cap is configured to communicate fluid into the channel.

### TECHNICAL FIELD

This disclosure relates generally to battery packs for electrified vehicles, and in particular relates to a manifold assembly for a battery pack.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on an internal combustion engine to propel the vehicle.

A high voltage battery pack typically powers the electric machines and other electrical loads of the electrified vehicle. The battery pack includes a plurality of battery cells and various other battery internal components that support electric propulsion of electrified vehicles.

The battery cells generate heat during charging and discharging operations. This heat must be dissipated in order to achieve a desired level of battery performance. Heat exchanger plates, sometimes referred to as “cold plates,” are often employed to dissipate the heat generated by the battery cells.

### SUMMARY

In some aspects, the techniques described herein relate to a battery pack, including: a battery array including a plurality of battery cells; a thermal exchange plate, wherein the thermal exchange plate includes a channel configured to communicate fluid from a first side of the thermal exchange plate to a second side of the thermal exchange plate; and a manifold assembly including a cap connected to the first side of the thermal exchange plate, wherein the cap is configured to communicate fluid into the channel.

In some aspects, the techniques described herein relate to a battery pack, wherein the cap is welded to the first side of the thermal exchange plate.

In some aspects, the techniques described herein relate to a battery pack, wherein the cap is brazed to the first side of the thermal exchange plate.

In some aspects, the techniques described herein relate to a battery pack, wherein the thermal exchange plate includes a plurality of channels configured to communicate fluid from the first side of the thermal exchange plate to the second side of the thermal exchange plate.

In some aspects, the techniques described herein relate to a battery pack, wherein the cap is configured to communicate fluid to each of the channels.

In some aspects, the techniques described herein relate to a battery pack, wherein: the cap is an inlet-side cap, and the manifold assembly includes an outlet-side cap connected to the to the second side of the thermal exchange plate, wherein the outlet-side cap is configured to collect fluid expelled from the channel.

In some aspects, the techniques described herein relate to a battery pack, wherein: the thermal exchange plate is one of a plurality of thermal exchange plates of the battery pack, each thermal exchange plate includes a channel configured to communicate fluid from a first side of the thermal exchange plate to a second side of the thermal exchange plate, the manifold assembly includes a plurality of inlet-side caps, with each of the inlet-side-caps connected to the first side of a respective one of the thermal exchange plates, and the manifold assembly includes a plurality of outlet-side caps, with each of the outlet-side caps connected to the second side of a respective one of the thermal exchange plates.

In some aspects, the techniques described herein relate to a battery pack, wherein: the battery pack further includes an enclosure assembly including an inlet and an outlet, the battery pack is configured to communicate fluid from the inlet to the outlet, a first conduit assembly is configured to communicate fluid from the inlet to each of the inlet-side caps, and a second conduit assembly is configured to communicate fluid from each of the outlet-side caps to the outlet.

In some aspects, the techniques described herein relate to a battery pack, wherein at least a portion of the first conduit assembly is integrally formed with each of the inlet-side caps.

In some aspects, the techniques described herein relate to a battery pack, wherein at least a portion of the second conduit assembly is integrally formed with each of the outlet-side caps.

In some aspects, the techniques described herein relate to a battery pack, wherein the battery array is a first battery array, and wherein a second battery array is within the enclosure assembly.

In some aspects, the techniques described herein relate to a battery pack, wherein the first battery array is vertically above the second battery array.

In some aspects, the techniques described herein relate to a battery pack, wherein: the thermal exchange plates are first thermal exchange plates, the inlet-side caps are first inlet-side caps, the outlet-side caps are first outlet-side caps, a plurality of second thermal exchange plates are between some battery cells of the second battery array, each of the second thermal exchange plates includes a channel configured to communicate fluid from a first side of the second thermal exchange plate to a second side of the second thermal exchange plate, the manifold assembly includes a plurality of second inlet-side caps connected to the first side of a respective one of the second thermal exchange plates, and the manifold assembly includes a plurality of second outlet-side caps connected to the second side of a respective one of the second thermal exchange plates.

In some aspects, the techniques described herein relate to a battery pack, wherein: the first conduit assembly is configured to communicate fluid from the inlet to each of the second inlet-side caps, and the second conduit assembly is configured to communicate fluid from each of the second outlet-side caps to the outlet.

In some aspects, the techniques described herein relate to a battery pack, wherein at least a portion of the first conduit assembly is integrally formed with each of the second inlet-side caps.

In some aspects, the techniques described herein relate to a battery pack, wherein at least a portion of the second conduit assembly is integrally formed with each of the second outlet-side caps.

In some aspects, the techniques described herein relate to a method, including: communicating fluid through a first cap connected to a first side of a thermal exchange plate to thermally condition a battery array.

In some aspects, the techniques described herein relate to a method, further including: collecting fluid expelled from thermal exchange plate with a second cap connected to a second side of the thermal exchange plate.

In some aspects, the techniques described herein relate to a method, wherein the thermal exchange plate includes channels configured to permit fluid to flow from the first cap to the second cap.

In some aspects, the techniques described herein relate to a method, wherein the first cap is welded to the first side of the thermal exchange plate and the second cap is welded to the second side of the thermal exchange plate.

### BRIEF DESCRIPTION OF THE DRAWINGS

FIG. 1 schematically illustrates an example powertrain of an electrified vehicle.

FIG. 2 is a perspective view of an example battery pack.

FIG. 3 is a cross-sectional view of the example battery pack, taken along line 3-3 from FIG. 2, and illustrates an example arrangement of a manifold assembly relative to two battery arrays.

FIG. 4 is a perspective view of a portion of a battery array relative to the manifold assembly.

FIG. 5 is a side view of a portion of the battery pack and illustrates an exemplary arrangement of the battery cells relative to thermal exchange plates.

FIG. 6 is a cross-sectional view taken along line 6-6 from FIG. 4 and illustrates additional detail of an arrangement of the manifold assembly relative to a thermal exchange plate.

### DETAILED DESCRIPTION

This disclosure relates generally to battery packs for electrified vehicles, and in particular relates to a manifold assembly for a battery pack. Among other benefits, which will be appreciated from the below description, this disclosure evenly distributes coolant relative to the cells of a battery array, which provides uniform heat transfer amongst the cells and leads to efficient heat transfer within the battery array.

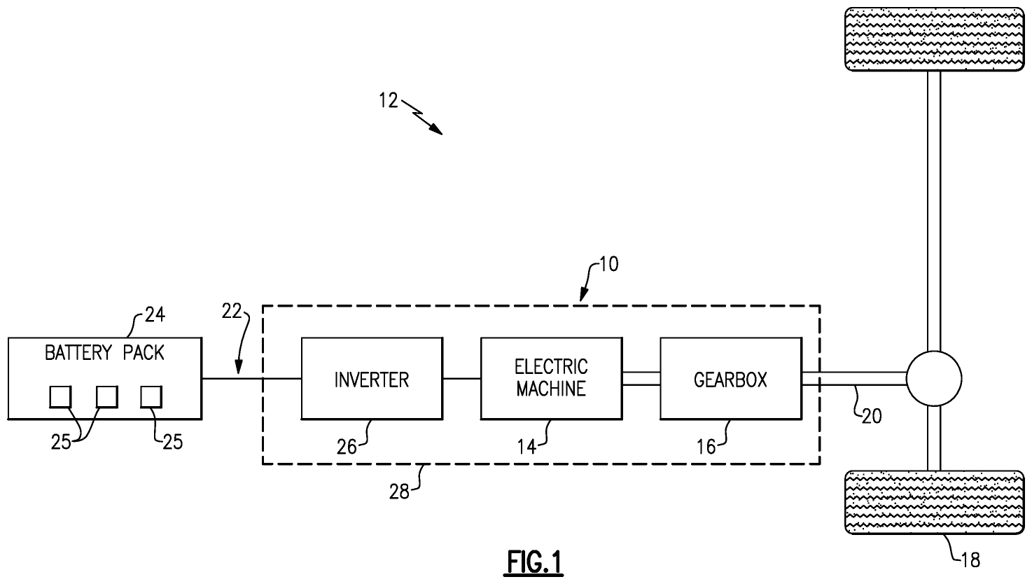

FIG. 1 schematically illustrates a powertrain 10 of an electrified vehicle 12. Although depicted as a battery electric vehicle (BEV), it should be understood that the concepts described herein are not limited to BEVs and could extend to other electrified vehicles, including but not limited to, plug-in hybrid electric vehicles (PHEVs). Therefore, although not shown in this embodiment, the electrified vehicle 12 could be equipped with an internal combustion engine that can be employed in combination with other energy sources to propel the electrified vehicle 12.

In a non-limiting embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The powertrain 10 shown in FIG. 1 is highly schematic and is not intended to limit this disclosure. Various additional components could alternatively or additionally be employed by the powertrain 10 within the scope of this disclosure.

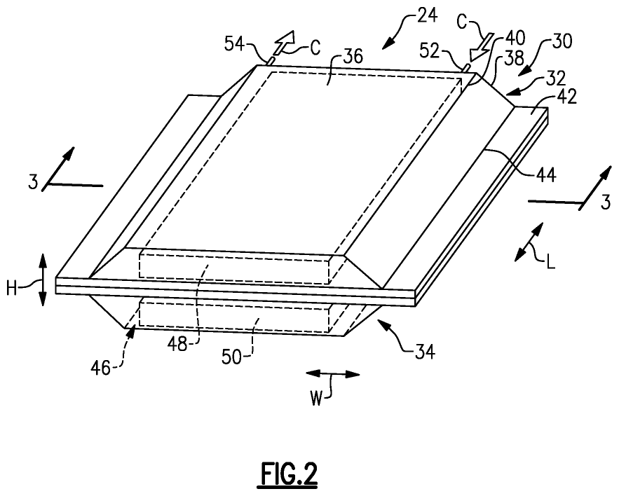

FIG. 2 illustrates additional detail of the example battery pack 24. In this example, the battery pack 24 includes an enclosure assembly 30. The enclosure assembly 30 includes a first portion 32, which here is a top portion or cover, and a second portion 34, which here is a bottom portion or tray. While the first portion 32 is vertically above the second portion 34, in this example, the first portion 32 could be arranged below, or to a side of the second portion 34. Various terms such as “above,” “below,” “top,” and “bottom” are used relative to the arrangement of the battery pack 24 in the various drawings and should not otherwise be deemed limiting.

In this example, the first portion 32 includes a substantially planar main section 36, an angled section 38 projecting toward the second portion 34 from an edge 40 of the main section 36 at a non-perpendicular angle relative to the main section 36, and a rim 42 projecting outward from an edge 44 of the angled section 38. The rim 42 is substantially parallel to the main section 36. The first portion 32 exhibits this arrangement about an entire perimeter of the first portion 32, in this example. The second portion 34 is sized and shaped substantially similar to the first portion 32. The first and second portions 32, 34 may be formed of a metallic material using a stamping process, for example.

The first and second portions 32, 34 are welded to one another by welding the respective rims 42 to one another. While welding is mentioned, the first and second portions 32, 34 could be connected using other fluid-tight connection techniques, such as using adhesive. Further, while an exemplary enclosure assembly 30 is shown in the drawings, the enclosure assembly 30 may vary in size, shape, and configuration within the scope of this disclosure.

The enclosure assembly 30 exhibits a length L, width W, and height H. The length L may extend parallel to a centerline of the electrified vehicle 12. The width W may extend substantially across an entire width of the electrified vehicle 12.

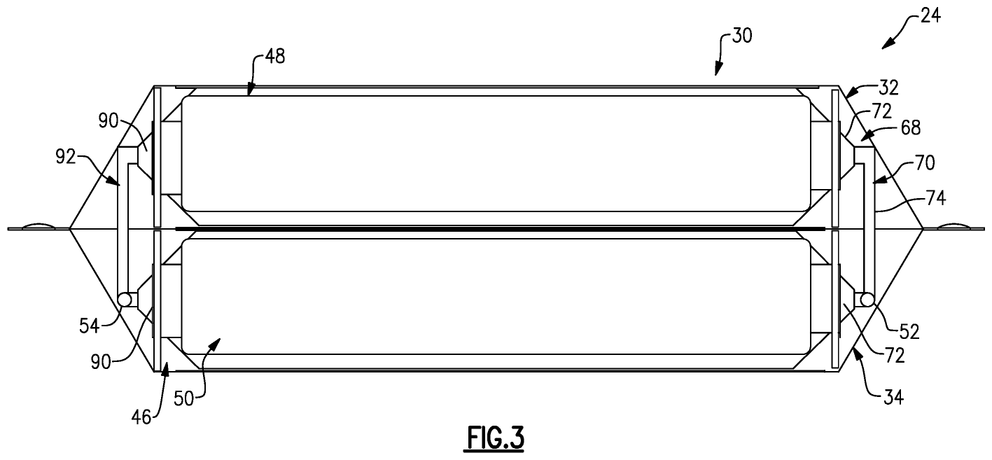

With joint reference to FIGS. 2 and 3, the enclosure assembly 30 defines a volume 46, which is specifically an inner volume of the enclosure assembly 30. Within the volume 46, the enclosure assembly 30 encloses a first battery array 48 and a second battery array 50 vertically below the first battery array 48. While two battery arrays are shown, this disclosure extends to battery packs with one or more arrays.

The battery pack 24 is configured to direct non-conductive coolant C relative to the first and second battery arrays 48, 50 to thermally condition the first and second battery arrays 48, 50, such as by absorbing heat from the first and second battery arrays 48, 50. The enclosure assembly 30 includes an inlet 52 on a first side of the first and second battery arrays 48, 50, and an outlet 54 on a second side of the first and second battery arrays 48, 50. Various fluid couplings may be provided relative to the inlet 52 and outlet 54. The coolant C may be referred to as thermal exchange fluid.

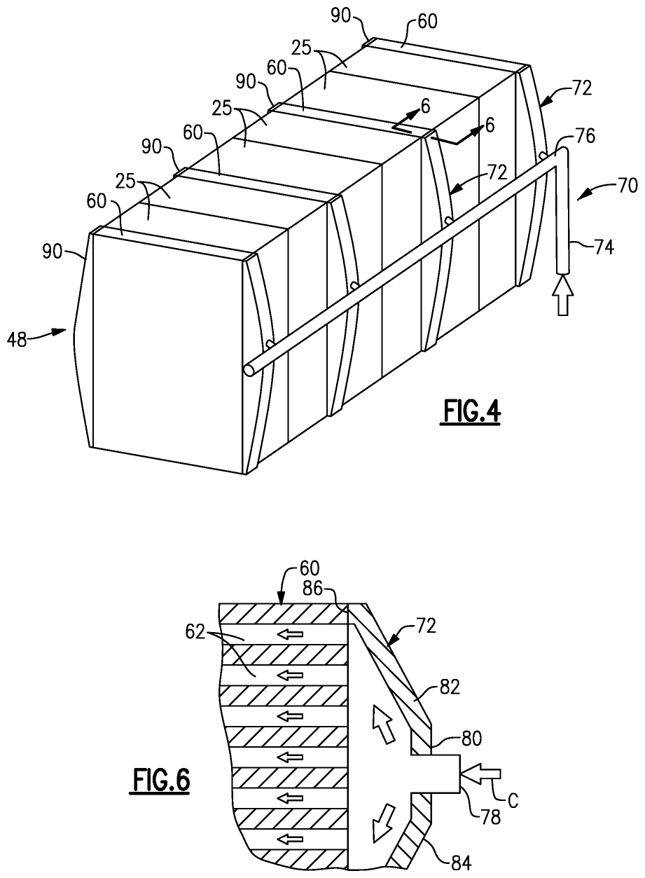

In this disclosure, the first and second battery arrays 48, 50 of battery cells 25 are generally stacked face-to-face, as shown in FIG. 4. The battery pack 24 could employ any number of battery cells 25 within the scope of this disclosure. As shown in FIG. 4, in one example, every two battery cells 25 are spaced-apart by a thermal exchange plate 60. The thermal exchange plates 60 may be considered part of the first battery array 48.

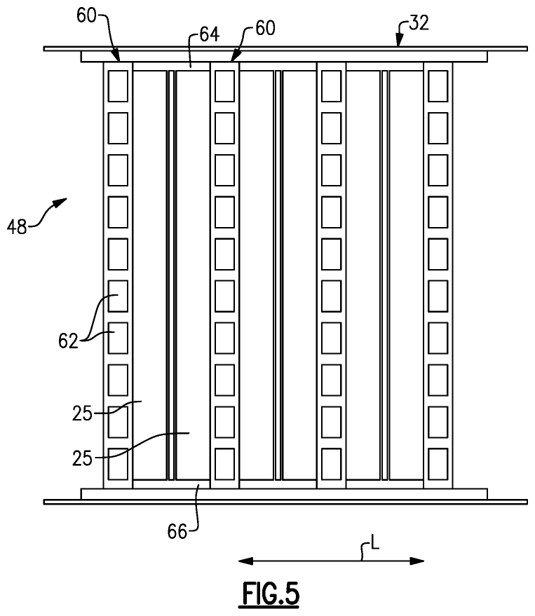

With reference to FIG. 5, each of the thermal exchange plates 60 includes a plurality of channels 62 configured to communicate coolant C from one side of the first battery array 48 to the other. Further, the battery cells 25 are arranged relative to the thermal exchange plates 60, in this example, such that voids 64, 66 are provided above and below the battery cells 25. The voids 64, 66 may be configured to communicate coolant C. The voids 64, 66 are not present in all examples. For instance, the thermal exchange plates 60 could include projections, which themselves could include channels for communicating coolant C, that reside in the location of the voids 64, 66.

In an embodiment, the battery cells 25 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

With reference to FIGS. 3 and 4, coolant C is distributed within the enclosure assembly by a manifold assembly 68, in this example. Specifically, the manifold assembly 68 is configured to direct coolant C from the inlet 52 to the thermal exchange plates 58, and is further configured to collect coolant C expelled from the thermal exchange plates 58 and direct that coolant C to the outlet 54.

The manifold assembly 68 includes an inlet-side, in this example, which is configured to direct coolant C from the inlet 52 to the thermal exchange plates 58. In this example, an inlet conduit assembly 70 directs coolant from the inlet 52 to a plurality of inlet-side caps 72. There is a first set of inlet-side caps 72 associated with the first battery array 48, and a second set of inlet-side caps 72 associated with the second battery array 50.

The inlet-side caps 72 are configured to connect to sides of the thermal exchange plate 60, as shown in FIGS. 4 and 6. The inlet conduit assembly 70 includes a vertical branch 74 and a feeder branch 76, in this example. The feeder branch 76 is configured to direct coolant into each of the inlet-side caps 72.

The inlet side caps 72 each include an inlet port 78, which is fluidly coupled to the feeder branch 76 using a fitting, for example. Alternatively, the feeder branch 76 can be integrally formed with each of the inlet side caps 72 associated with the first array 48. Further, in another example, the entire inlet conduit assembly 70 can be integrally formed with each of the inlet-side caps 72 associated with the first and second arrays 48, 50.

In this example, the inlet-side caps 72 each include a main section 80, which extends parallel to the height H, and first and second angled sections 82, 84 projecting away from the main section 80 at a non-perpendicular angle thereto. The incline of the first and second angled sections 82, 84 assists with evenly dispersing coolant C. The first and second angled sections 82, 84 extend to a perimeter rim 86, which is on an opposite side of the inlet-side cap 72 as the main section 80. The perimeter rim 86 is sized and shaped to surround each of the channels 62 of a thermal exchange plate 60. The perimeter rim 86 is also sized and shaped such that the perimeter rim 86 can be connected directly to the thermal exchange plate 60 by welding or brazing, as examples, which provides a fluid-tight connection. The fluid-tight connection can alternatively or additionally be provided using adhesives, fasteners, and/or gaskets. Each of the inlet-side caps 72 may be formed of a metallic material using known techniques such as stamping, as an example.

While an example inlet conduit assembly 70 and inlet-side cap 72 have been shown, it should be understood that modifications of the inlet conduit assembly 70 and inlet-side cap 72 come within the scope of this disclosure.

The manifold assembly 68 further includes a plurality of outlet-side caps 90 configured in substantially the same manner as the inlet-side caps 72. Specifically, the manifold assembly 68 includes a first set of outlet-side caps 90 associated with the first battery array 48, and a second set of outlet-side caps 90 associated with the second battery array 50. The outlet-side caps 90 are configured to collect coolant C expelled from the thermal exchange plates 58 and direct that coolant to the outlet 54 via an outlet conduit assembly 92, which is configured substantially the same as the inlet conduit assembly 70.

The term manifold assembly is used in this disclosure to refer to pipes, conduits, or chambers that direct fluid from a single location to multiple locations (e.g., the inlet-side of the manifold assembly 68), and the term manifold assembly is inclusive of any pipes, conduits, chambers that collect fluid from multiple locations and direct that fluid to a single location (e.g., the outlet-side of the manifold assembly 68).

The inlet and outlet conduit assemblies 70, 92 may each include one or more hoses and pipes, etc., and those hoses/pipes may further include various valves, fittings, couplings, etc., to establish the above-described connections. Further, as described above relative to the inlet conduit assembly 70, at least some parts of the outlet conduit assembly 92 may be integrally formed with the outlet-side caps 90.

In use, as shown in FIGS. 4 and 6, coolant C flows from the inlet 52 to the inlet conduit assembly 70, which directs the coolant C relative to each of the inlet-side caps 72. The inlet-side caps 72 direct coolant C through the thermal exchange plates 60 to absorb heat from the first and second battery arrays 48, 50. Coolant C expelled from the thermal exchange plates 60 enters the outlet-side caps 90, which collect that coolant C. The coolant C is then directed to the outlet 54 via the outlet conduit assembly 92.

The coolant C may be a non-conductive coolant C, such as a dielectric fluid designed for immersion cooling the battery cells 25. One suitable non-conductive fluid is a Novek™ engineered fluid sold by 3M™. However, other non-conductive fluids may also be suitable, and the actual chemical make-up and design characteristics (e.g., dielectric constant, maximum breakdown strength, boiling point, etc.) may vary depending on the environment the array 48 is to be employed within. Unlike the conductive glycol utilized within known cold plate systems, the non-conductive fluid received inside the immersion cooled battery arrays of this disclosure allows for direct contact with the battery cells and other electrified components without causing electrical shorts, thereby improving cooling and performance. The exemplary immersion cooling strategies further enable high rate charging and discharging and allow for high load demands without increasing the hardware size of the battery arrays.

It should be understood that terms such as “about,” “substantially,” and “generally” are not intended to be boundaryless terms, and should be interpreted consistent with the way one skilled in the art would interpret those terms. It should also be understood that directional terms such as “upper,” “top,” “vertical,” “forward,” “rear,” “side,” “above,” “below,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
a battery array including a plurality of battery cells;
a thermal exchange plate, wherein the thermal exchange plate includes a channel configured to communicate fluid from a first side of the thermal exchange plate to a second side of the thermal exchange plate; and
a manifold assembly including a cap connected to the first side of the thermal exchange plate, wherein the cap is configured to communicate fluid into the channel.

2. The battery pack as recited in claim 1, wherein the cap is welded to the first side of the thermal exchange plate.

3. The battery pack as recited in claim 1, wherein the cap is brazed to the first side of the thermal exchange plate.

4. The battery pack as recited in claim 1, wherein the thermal exchange plate includes a plurality of channels configured to communicate fluid from the first side of the thermal exchange plate to the second side of the thermal exchange plate.

5. The battery pack as recited in claim 4, wherein the cap is configured to communicate fluid to each of the channels.

6. The battery pack as recited in claim 1, wherein:
the cap is an inlet-side cap, and
the manifold assembly includes an outlet-side cap connected to the to the second side of the thermal exchange plate, wherein the outlet-side cap is configured to collect fluid expelled from the channel.

7. The battery pack as recited in claim 6, wherein:
the thermal exchange plate is one of a plurality of thermal exchange plates of the battery pack,
each thermal exchange plate includes a channel configured to communicate fluid from a first side of the thermal exchange plate to a second side of the thermal exchange plate,
the manifold assembly includes a plurality of inlet-side caps, with each of the inlet-side-caps connected to the first side of a respective one of the thermal exchange plates, and
the manifold assembly includes a plurality of outlet-side caps, with each of the outlet-side caps connected to the second side of a respective one of the thermal exchange plates.

8. The battery pack as recited in claim 7, wherein:
the battery pack further includes an enclosure assembly including an inlet and an outlet,
the battery pack is configured to communicate fluid from the inlet to the outlet,
a first conduit assembly is configured to communicate fluid from the inlet to each of the inlet-side caps, and
a second conduit assembly is configured to communicate fluid from each of the outlet-side caps to the outlet.

9. The battery pack as recited in claim 8, wherein at least a portion of the first conduit assembly is integrally formed with each of the inlet-side caps.

10. The battery pack as recited in claim 8, wherein at least a portion of the second conduit assembly is integrally formed with each of the outlet-side caps.

11. The battery pack as recited in claim 8, wherein the battery array is a first battery array, and wherein a second battery array is within the enclosure assembly.

12. The battery pack as recited in claim 11, wherein the first battery array is vertically above the second battery array.

13. The battery pack as recited in claim 11, wherein:
the thermal exchange plates are first thermal exchange plates,
the inlet-side caps are first inlet-side caps,
the outlet-side caps are first outlet-side caps,
a plurality of second thermal exchange plates are between some battery cells of the second battery array,
each of the second thermal exchange plates includes a channel configured to communicate fluid from a first side of the second thermal exchange plate to a second side of the second thermal exchange plate,
the manifold assembly includes a plurality of second inlet-side caps connected to the first side of a respective one of the second thermal exchange plates, and
the manifold assembly includes a plurality of second outlet-side caps connected to the second side of a respective one of the second thermal exchange plates.

14. The battery pack as recited in claim 13, wherein:
the first conduit assembly is configured to communicate fluid from the inlet to each of the second inlet-side caps, and
the second conduit assembly is configured to communicate fluid from each of the second outlet-side caps to the outlet.

15. The battery pack as recited in claim 14, wherein at least a portion of the first conduit assembly is integrally formed with each of the second inlet-side caps.

16. The battery pack as recited in claim 15, wherein at least a portion of the second conduit assembly is integrally formed with each of the second outlet-side caps.

17. A method, comprising:
communicating fluid through a first cap connected to a first side of a thermal exchange plate to thermally condition a battery array.

18. The method as recited in claim 17, further comprising:
collecting fluid expelled from thermal exchange plate with a second cap connected to a second side of the thermal exchange plate.

19. The method as recited in claim 18, wherein the thermal exchange plate includes channels configured to permit fluid to flow from the first cap to the second cap.

20. The method as recited in claim 18, wherein the first cap is welded to the first side of the thermal exchange plate and the second cap is welded to the second side of the thermal exchange plate.
